(19) United States
(12) Patent Application Publication
(10) Pub. No.: US 2008/0275168 A1
(43) Pub. Date: Nov. 6, 2008

(54) STAIN FOR INTERIOR AND EXTERIOR DECORATIVE WOOD SUBSTRATES

(76) Inventor: John Friederich Schierlmann, Hickory, NC (US)

Correspondence Address: FAY SHARPE LLP, 1100 SUPERIOR AVENUE, SEVENTH FLOOR, CLEVELAND, OH, 44114, US

(21) Appl. No.: 12/114,944

(22) Filed: May 5, 2008

Related U.S. Application Data
(60) Provisional application No. 60/927,326, filed on May 3, 2007.

(51) Int. Cl. C08L 77/06; C08L 1/02; C08K 5/053

(52) U.S. Cl. 524/35; 524/606; 524/386

(57) ABSTRACT

The present invention is directed to a solvent or water based coating composition comprising a one step stain and topcoat. The solvent based one-step composition comprises at least one of an alkyd or oil modified urethane polymer, one or more surfactants to provide smooth uniform coatings and at least one micro pigment particle of less than about 2 μm. The water-based composition comprises at least one of self-crosslinking acrylic, oxidizable polyurethane dispersion and polyurethane dispersion polymers, at least one coalescing aid, one or more cross-linker to enhance the tensile strength of the cured coating and improve its chemical resistance, a thickener to increase viscosity of the dispersions, one or more surfactants to provide smooth uniform coatings and at least one micro pigment particle of less than 2 μm. The present invention is further directed to a water based stain for coloring wood.

### BACKGROUND

This invention relates to finishing of wood objects. More particularly, the invention relates to a product, and a method of its use, for finishing or refinishing wood floors or furniture.

Hardwood floors have been employed in quality housing and offices for more than 150 years and have also been used in the manufacture of furniture for countless generations. To improve the ability of the surface of the wood to withstand wear and tear, while making it attractive in appearance, the wood is subjected to smoothing and finishing steps.

Wood finish coatings (referred to herein alternatively as a coating and a finish) are required to withstand a great deal of traffic and wear to protect the wood beneath. Common coatings are solvent and/or water based. Polyurethane and acrylic based coatings are the most common in the industry.

Conventional finishing methods for wood coatings involve first staining the wood, followed by applying a topcoat. This takes at least two days to complete the job. Having the ability to deliver a stain and topcoat in one application saves time. The problem has been that traditional stain in a topcoat can migrate and may appear blotchy, streaky, and too opaque.

The present invention is directed to a stain inclusive topcoat for coloring and finishing wood which provides certain advantages.

### SUMMARY

In one embodiment, the present invention is directed to a solvent based coating composition comprising a one step stain and topcoat for coloring and finishing wood, metal, and fiberglass The one-step composition comprises at least one of an alkyd or oil modified urethane polymer, at least one coalescing aid, one or more cross-linker to enhance the tensile strength of the cured coating and improve its chemical resistance, a thickener to increase viscosity of the dispersions, one or more surfactants to provide smooth uniform coatings; and at least one micro pigment particle of less than about 2 μm. The composition has a finish of at least one of gloss, semi gloss and satin.

Another embodiment of the present invention is directed to a water-based coating composition comprising a one step stain and topcoat for coloring and finishing wood, metal and fiberglass. The composition of this embodiment comprises at least one of self-crosslinking acrylic, oxidizable polyurethane dispersion and polyurethane dispersion polymers, at least one coalescing aid, one or more cross-linker to enhance the tensile strength of the cured coating and improve its chemical resistance, a thickener to increase viscosity of the dispersions, one or more surfactants to provide smooth uniform coatings and at least one micro pigment particle of less than 2 μm. The composition has a finish of at least one of gloss, semi gloss and satin.

Yet another embodiment of the present invention is directed to a water based stain for coloring wood. The stain of this embodiment comprises at least one of self-crosslinking acrylics, water dispersed alkyds and water dispersed polymers, at least one coalescing aid, one or more cross-linker to enhance the tensile strength of the cured coating and improve its chemical resistance, a thickener to increase viscosity of the dispersions, one or more surfactants to provide smooth uniform coatings and at least one micro pigment particle of less than 2 μm in size.

### DETAILED DESCRIPTION

This application incorporates by reference the description set forth in Provisional Application No. 60/297,326, filed May 3, 2007. While the invention will be described in connection with certain exemplary embodiments, it will be understood that it is not intended to limit the invention to those embodiments. On the contrary, it is intended to cover all alternatives, modifications, and equivalents that may be included within the spirit and scope of the invention defined by the appended claims.

The present coating includes, as one component, polymers that are capable of crosslinking (e.g. urethane/acrylic copolymers, aliphatic urethanes, acrylic copolymers, and other polymers containing pendant carboxylic acid groups). Suitable polymers of urethane, acrylic, and urethane/acrylic copolymers (i.e., a polymer containing urethane and acrylic moieties) for use in the compositions of the present invention are those that are capable of forming stable dispersions in water or other solvents (e.g., hydrocarbon based). One specific example of a non film-forming urethane/acrylic copolymer is a high solids, monomer-free, radiation-curable, water-borne urethane/acrylic copolymer, which is commercially available under the trade designation “NeoRad 3709” from NeoResins, a division of Avecia, Wilmington, Mass. Specific examples of urethane and acrylic polymers include NEOREZ R9036 and NEOCRYL XK-12. These urethane/acrylic polymers and copolymers are designed for uses where hardness, flexibility, UV resistance, and chemical resistance are desired.

In solvent-based coating systems, exemplary polymers are urethane polymers, such as high solids oil modified urethanes and conventional oil modified urethanes. The oil may be a byproduct of the reaction of a drying oil, such as linseed, soybean, sunflower, and dehydrated castor oil, with toluene diisocyanate. The high solids oil modified urethanes preferably have a solids content greater than about 75%. High solids oil modified urethanes include Reichhold F87, (Durham, N.C.), Hexion 57-5849 (Carpentersville, Ill.), and EPS 4842, (Marengo, Ill.). The conventional oil modified urethane polymers preferably have a solids content less than about 75 wt %. Exemplary conventional oil modified urethane polymers include Reichhold F-14, Hexion 43-4305, and EPS 4603.

In water-based systems, the preferred polymers are self-crosslinking acrylics and self-crosslinking urethanes. The self crosslinking acrylic can be an emulsion with an internal crosslinking agent to promote better performance in film properties. Exemplary self crosslinking acrylics include Lubrizol Carboset 4010, (Brecksville, Ohio), BASF (SC Johnson) Joncryl 1972 (Sturtevant, Wis.), and Neoresins Neocryl XK-12. Preferred self-crosslinking urethane polymers include Lubrizol 2025, and DSM Neorez R9018.

The coating composition of the present invention can have a total solids content between about 15 and 80 wt %, or between about 10 and 75 vol %. This total weight percent can be achieved by varying the amounts of high and low solids polymers used in the overall coating composition.

The curable coating composition of the present invention may optionally use a glycol ether as a coalescing aid. The coalescing aid can enhance film formation and increase the flexibility of the coating. The coalescing aid can also function as a wetting agent. Suitable glycol ether coalescing aids are commercially available from The Dow Chemical Company, Midland Mich., under the trade designation Dowanol.

The coalescing aid, or a mixture of coalescing aids, is present in the coating composition in an amount effective to meld the urethane/acrylic particles during the drydown or curing stage and thereby allow a continuous film to form. The coalescing aid, or a mixture of such coalescing aids can comprise less than about 15 wt % of the coating composition in an amount based on the weight of polymer solids. The coating composition can include about 1-10 wt %, or even about 3-8 wt %, coalescing aid, based on the weight of polymer solids.

A crosslinker is optionally included in the curable coating compositions of the present invention to enhance the tensile strength of the cured coating and improve its chemical resistance. Suitable crosslinkers are those that can be used to crosslink urethane/acrylic polymers or copolymers, and are stable in alkaline solutions. Examples of such crosslinkers include, but are not limited to, epoxy silanes, amino silanes, and aziridine derivatives. Suitable epoxy silanes include Z-6040 available from Dow Corning. Suitable aminosilanes include Z 6020 available from Dow Corning. Suitable polyfunctional aziridines are those commercially available under the trade designations XAMA-2 (trimethylolpropane-tris-(β-N-aziridinyl)propionate) and XAMA-7 (pentaerythrito-tris-(β-N-aziridinyl) propionate) from B.F. Goodrich Chemical Company, and NeoCryl CX-100 from Zeneca Resins (Wilmington, Mass.). These crosslinkers are particularly desirable because they also function as adhesion promoters to materials such as polyester, glass, etc. They are preferably used with polymers containing active hydrogens, such as the urethane/acrylic copolymers described above that contain pendant carboxylic acid groups.

The alkaline-stable crosslinker, or mixture of alkaline stable crosslinkers, can be present in the coating composition in an amount effective to provide a durable cured coating. Preferably, the alkaline-stable crosslinker is present in the coating composition in an amount from about 0.1-10 wt % and more preferably about 0.5-6 wt % based on the weight of the polymer solids.

Alternatively, the coating composition may be photochemically cured. If photochemically cured, the curing reaction is preferably initiated by ultraviolet light and the selected urethane and acrylic polymers can be capable of self-curing.

A thickener may be used in the coating composition to increase the viscosity of the dispersions. This is sometimes important to provide coatings that do not sag. Suitable thickeners are those that are compatible with urethane/acrylic dispersions. As used herein “compatible” means that the component does not cause adverse affects to the curable compositions (e.g. precipitation, flocculation, or other separation of the components), or to the cured coating (e.g. disruption of film continuity, phase separation, or loss of adhesion to the backing). The thickeners can be associative thickeners. An “associative” thickener is a polymeric compound having hydrophobic groups that associate with the dispersed polymer particles of the curable coating compositions. This association is believed to result in adsorption of the thickener molecule onto the dispersed polymer particles. Exemplary thickeners include Natrosol 250 MR, (Hercules), RM-2020 (Rohm-Haas, Independence Mall West, Philadelphia, Pa.), Rheolate 266 (Rheox, Hightown, N.J.), and DSX 1514 (Cognis Coating, Ambler, Pa.).

Silica flatting agents can be added to the finishes of the present invention to aid in the lowering of gloss, without loss of clarity, in semi-gloss and satin applications. Preferred silica flatting agents are silicon dioxide. The silica flatting agent may also have a synergistic effect on the drying system of both conventional and high solids solvent based urethanes. The silica can have a particle size of between about 1 and 15 μm, or a particle size between about 1.5 and 12 μm. Exemplary silica flatting agents include Crossfield HP 210 (Joliet, Ill.), Grace C-810 (Columbia, Md.), and Degussa HK-450 (Ridgefield, N.J.). The silica flatting agents can comprise about between about 0.1 and 15 wt % of the total composition, or between about 0.3 and 10 wt %. In gloss applications, the finish is substantially free of silica. In semi-gloss applications, the finish can include between about 0.5 and 10 wt % silica. In satin applications, the finish can include between about 2 and 15 wt % silica.

Surfactants may be used in the coating composition to provide smooth, uniform coatings. A wide variety of surfactants, i.e., surface-active agents, are suitable for use in the curable coating compositions of the present invention.

Suitable surfactants include, but are not limited to, flow control agents, wetting agents, dispersants, adhesion enhancers, defoamers, etc. The preferred surfactants can be nonionic or anionic. Examples of surfactants are available under the trade designation “Silwet L-7210” (a nonionic polyalkeneoxide modified polydimethylsiloxane) (Osi Specialties, Inc., Danbury, Conn.), “BYK 346” (a nonionic polyalkeneoxide modified polydimethylsilioxan), “Surfynol 104PA” (2,4,7,9-tetramethyl-5-decyn-4,7-diol) (Air Products and Chemicals, Inc., Allentown, Pa.) and “Triton GR-7M” (an anionic sulfosuccinate) from (Union Carbide Chemicals and Plastics Co., Inc., Danbury, Conn.).

Flow control agents are organic compounds capable of helping the coating wet the substrate and flow over possible contaminations. Exemplary flow control agents are sold under the trade names BYK 344 (BYK Chemie, Wallingford, Conn.), Air Products HS-30, and Witco L-7500. Organic dispersants are hydrocarbon modified surface acting agents with acid or basic functionality designed to aid in the separation of pigment agglomerates. Exemplary dispersants include Anti terra (BYK Chemie).

Organic defoamers are another class of surfactants that may be included in the coating compositions of the present invention. Organic defoamers are hydrocarbon modified liquids, sometimes with silicone modification. The defoamer serves to break bubbles and air entrapment in the system. An exemplary defoamer is sold under the trade name BYK-077 (BYK Chemie).

A surfactant, or mixture of surfactants, can be present in the coating composition in an amount effective to provide a smooth, uniform coating. The surfactant, or mixture of surfactants, can be present in the curable coating compositions of the present invention in an amount of about 0.1-5 wt % and more preferably, about 0.5-3 wt %, based on the total weight of the curable coating composition (including solvent or water).

The finish of the present invention further includes microlith pigment. The microlith pigments are smaller in particle size than traditional pigment. Due to the smaller pigment particle size, they have better clarity than products made with traditional pigment dispersions. Further, the stains not only color the wood as a stain wood, but also highlight and contrast the grain in open grain woods such as oak, ash or mahogany. The particle size (i.e., maximum particle diameter) of the microlith or keygloss/keysperse pigment is preferably less than about 2 micrometers, more preferably less than about 750 nm, and most preferable less than about 250 nm. Exemplary microlith pigments are available from Ciba Specialty Chemicals, Tarrytown, N.Y. Exemplary keysperse and keygloss pigments are available from Keystone, Chicago, Ill.

The microlith pigments can comprise between about 0.1 and 5 wt % of the overall coating composition, or between about 0.1 and 2.5 wt %.

The microlith pigment can be dispersed either into an oil modified urethane or alkyd for a solvent-based material. For a water-based material, the microlith can be dispersed into a water-alcohol medium and used as a tinting medium for an acrylic, polyurethane dispersion or alkyd system. The high performance pigments can be predispersed in a resin, which is compatible with a wide range of polymers.

The microlith pigment preparations can easily be stirred into a large number of organic solvents, lacquers and printing-ink binding agents. The base pigments are present in extraordinarily fine particles. This makes the product very versatile and gives it advantages such as good dispersion stability, and very strong and light-fast colors.

The keygloss pigment dispersions can easily be stirred into a large number of organic solvents, lacquers and printing-ink binding agents. The base pigments are present in extraordinarily fine particles. This makes the product very versatile and gives it advantages such as good dispersion stability, and very strong and light-fast colors.

The microlith pigments can also be easily incorporated into an alkaline water/alcohol mixture. This means that pigment dispersions with a very high level of transparency, suitable among others for wood stains, can be prepared very easily. These pigment dispersions can also be combined with other colorants as required. In order to obtain good storage stability of the pigment dispersion the addition of a stabilizing resin is recommended.

The keysperse pigment dispersions can also be easily incorporated into a large number of acrylics, polyurethane dispersions, alkyd resin emulsions or water-based resin solutions. This means that pigment dispersions with a very high level of transparency, suitable among others for wood stains, can be prepared very easily. These pigment dispersions can also be combined with other colorants as required. In order to obtain good storage stability of the pigment dispersion the addition of a stabilizing resin is recommended.

The microlith pigment containing finish advantageously requires less pigmentation to achieve the same coloration level relative to traditional course oxide or organic grade pigments. The finished product can look as though one has stained the substrate and then applied a topcoat to the stained material.

The present inventive finish can be used on wood, metal, glass, plastic (non-wood) surfaces, and fiberglass in combination with polyurethane with different color combinations to create stained or molded looks.

The finish can be applied with a brush, spray equipment, or aerosol can with one to five coats of material. An exemplary film thickness as applied is one dry mil.

The micro pigment offer advantages in the following applications in surface coatings:
In systems where a lesser amount of pigment contributes to depth of coloration of the wood substrate;
in systems where the binder has unsatisfactory pigment wetting properties;
in systems requiring optimum pigment; dispersion such as transparent, translucent or metallic finishes;
in tinting applications. Micro pigment preparations dispersed in solvents can be used for this purpose instead of pigment pastes. Particularly where the latter have a high binder content—which is usually the case—the addition of too large amounts of a foreign binder can interfere with the pigment dispersion of the system, for example in hammer finishes;
in the production of multipurpose stains for those surface coating systems with which the micro carrier resin is compatible;
to increase output in paint factories where the dispersion equipment is overloaded; and
generally, in all systems in which the use of micro pigment preparations will improve the technical properties and performance of the finish.

The top coat/stain of the invention can be prepared by combining the solvent, except the quantity used for dissolving the binder, in a vessel with an impeller. Dead spots should be avoided in the vessel to ensure complete circulation. The solvent is stirred slowly and the micro pigment preparation added in portions.

The dispersion process starts once the speed of the impeller has been increased to 6 to 10 m/sec. The binder and other components of the formulation are added and intensive stirring is continued for a further 30 minutes. If necessary, the mixture can then be filtered or centrifuged. This method can be used to incorporate micro pigment preparations into a wide range of surface coating systems, and will ensure good dispersion and good final color strength. The need for retinting is avoided as well as the associated danger of a change in hue.

### EXAMPLES

### Example 1

### Solvent Based Stain and Polyurethane Finish

To a kettle was charged 300 lbs (38.9 gal) oil modified urethane, and 29.7 lbs (3.57 gal) long oil alkyd. The mixer was started and 17.9 lbs (1.04 gal) silica flatting agent (Acematt HK450), 1.49 lbs (0.21 gal) organic dispersant (Antiterra 202), 2.5 lbs (0.25 gal) (microlith pigment T), 24.8 lbs (3.39 gal) solvent (solvent 100), 14.9 lbs (1.88 gal) oxygenated solvent (propylene glycol methyl ether acetate) were added. The components were thoroughly mixed for approximately 5 minutes. After color is dispersed and grind is reached, 3.0 lbs (0.40 gal) thickener-settle agent (Disparlon 6900) was added and the mixture was agitated at moderate speed until the thickener was dispersed. 102.2 lbs (15.2 gal) mineral spirits and 200 lbs (26 gal) conventional oil modified urethane was then added to the mixture. In a separate container, 15 lbs (2.26 gal) Rule 66 mineral spirits solvent, 1.27 lbs (0.15 gal) Cobalt surface drier, 8 lbs (0.78 gal) zirconium through drier, 1.0 lbs (0.15 gal) organic defoamer (BYK 053), 4 lbs (0.55 gal) calcium auxiliary drier), 3 gal (0.38 gal) flow agent (BYK 300), and 2.5 lbs (0.32 gal) antiskinning agent (Skino #2) were premixed then added to the reaction kettle. The reaction mixture was agitated for an additional 30 minutes.

### Example 2

### Water Based Stain and Polyurethane Coating Composition

To a master tank kettle was charged 400 lbs (45.3 gal) self crosslinking acrylic (Neores XK-15), 210 lbs (25.5 gal) water, 0.23 lbs (0.024 gal) defoamer (BYK 035), 175.9 kg (75.67 L) self crosslinking urethane (Reichhold F-97). The components were mixed thoroughly.

To a separate kettle was charged 10 lbs (1.16 gal) freeze thaw agent (propylene glycol), 43 lbs (5.4 gal) hydrophilic solvent(tripropylene glycol monomethyl ether), and 10 lbs (1.3 gal) hydrophobic solvent(dipropylene glycol monobutyl ether). The components were mixed thoroughly, and added to master tank.

In a separate kettle was charged, 18.9 lbs (2.3 gal) water, 6.6 lbs (0.74 gal) thickener (DSX-1514), 0.19 lbs (0.02 gal) biocide (Proxel GXL), 1.89 lbs (0.23 gal) flow and level aid (BYK 346), 2.36 lbs (0.30 gal) flow aid adhesion promoter (Surfynol 104DPM), 1.9 lbs (0.17 gal) preservative (Butrol 35), and 2.83 lbs (0.34 gal) Tego Foamex 815 under agitation. This premix was added to the master tank kettle under agitation

The colorants were added to the master tank kettle under agitation. Pigments were in a dispersion of 40-50% ethanol (90%), 40-50% water, 0.1-0.5% 28 baume ammonia and 10% microlith pigment (4.6 lbs).

### Example 3

### Water-Based Stain Composition

To a kettle was charged 580 lbs (70 gal) water, and 5 lbs (0.5 gal) cellulosic thickener (Lattice NBS-80), the solution is mixed for 10-15 minutes, then 1.5 lbs (0.2 gal) amine (AMP-95) was added. The components were mixed thoroughly for 10-15 additional minutes, until the viscosity increased.

To the kettle was charged 8 lbs (0.8 gal) freeze thaw agent (glycerine), 50 lbs (5.5 gal) water dispersed alkyd (DSM XP 7600), 75 lbs (9.5 gal) water emulsified soybean oil (Formeze), and 65 lbs (7.3 gal) water based acrylic (Noveon 510).

Finally to the kettle was charged, 0.19 lbs (0.02 gal) biocide (Proxel GXL), and 3.5 lbs (0.34 gal) Tego Foamex 822 under agitation. The colorants were added under agitation. Micro pigments were made in a dispersion of 10-50% ethanol 90%, 10-60% water, 0.1-0.5% 28 baume ammonia and 1-20% micro pigment.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A solvent based coating composition comprising a stain and topcoat, said composition comprising:
at least one of an alkyd or oil modified urethane polymer;
one or more surfactants; and
at least one micro pigment particle of less than about 2 μm, wherein said composition has a finish of at least one of gloss, semi gloss and satin.

2. The solvent based coating composition of claim 1, wherein the total solids content is between about 6 and 75 wt. %.

3. The solvent based coating composition of claim 1, wherein said coating further comprises silica flatting agents.

4. The solvent based coating composition of claim 1, wherein said micro pigment is less than about 250 nm.

5. The solvent based coating composition of claim 1, wherein said micro pigment comprises about 0.1-10 wt % of the total composition.

6. The solvent based coating composition of claim 1, wherein said micro pigment is predispersed in a resin.

7. A water based coating composition comprising:
at least one of self-crosslinking acrylic, oxidizable polyurethane dispersion, one water-based alkyd dispersion and polyurethane dispersion polymers;
at least one coalescing aid;
a thickener;
one or more surfactants; and
at least one micro pigment particle of less than 2 μm, wherein said composition has a finish of at least one of gloss, semi gloss and satin.

8. The water based coating composition of claim 7, wherein said coalescing aid is a glycol ether.

9. The water based coating composition of claim 7, wherein said coalescing aid comprises less than about 15 wt. % of the total composition.

10. The water based coating composition of claim 7, wherein said thickener is one of at least a cellulose thicker and an associative thickener.

11. The water based coating composition of claim 7, wherein said micro pigment is less than about 250 nm.

12. The water based coating composition of claim 7, wherein said micro pigment comprises about 0.1-10 wt % of the total composition.

13. The water based coating composition of claim 9, wherein said micro pigment is predispersed in a resin.

14. A water based stain for coloring wood, said stain comprising:
at least one of self-crosslinking acrylics, water dispersed alkyds and water dispersed polymers;
at least one coalescing aid;
one or more cross-linker;
a thickener;
a freeze thaw;
one or more surfactants; and
at least one micro pigment particle of less than 2 μm in size.

15. The water based stain of claim 14, wherein the total solids content is between about 5 and 65 wt. %.

16. The water based stain of claim 14, wherein said coalescing aid is a glycol ether.

17. The water based stain of claim 14, wherein said freeze thaw agent is glycerine.

18. The water based stain of claim 14, wherein said micro pigment is less than about 250 nm.

19. The water based coating composition of claim 14, wherein said micro pigment comprises about 0.1-10 wt % of the total composition.

20. The water based coating composition of claim 14, wherein said micro pigment is predispersed in a resin.
